(19) United States
(12) Patent Application Publication
(10) Pub. No.: US 2024/0126587 A1
(43) Pub. Date: Apr. 18, 2024

(54) Apparatus, Device, Method, Computer Program and Computer System for Determining Presence of a Noisy Neighbor Virtual Machine

(71) Applicant: Intel Corporation, Santa Clara, CA (US)

(72) Inventors: Mona MINAKSHI, Hillsboro, OR (US); Shamima NAJNIN, Portland, OR (US); Rajesh POORNACHANDRAN, PORTLAND, OR (US)

(21) Appl. No.: 18/394,677

(22) Filed: Dec. 22, 2023

(51) Int. Cl. G06F 9/455

(52) U.S. Cl. CPC G06F 9/45558; G06F 2009/4557; G06F 2009/45591

(57) ABSTRACT

Examples relate to an apparatus, a device, a method, a computer program (or computer-readable medium) and computer system for determining presence of a noisy neighbor virtual machine. Some aspects of the present disclosure relate to an apparatus for a computer system, the apparatus comprising interface circuitry, machine-readable instructions, and processor circuitry to execute the machine-readable instructions to obtain performance information of one or more hardware performance measurement components of the computer system, determine, based on the performance information, a deviation of a utilization of the computer system from an expected utilization of the computer system, and determine presence of a first virtual machine having a workload that impacts a performance of one or more second virtual machines based on the deviation.

### BACKGROUND

Presently, a usage of cloud-based computing has grown, and more businesses are expected to continue migrating to a cloud infrastructure, which is dominated by virtualized use cases.

The cloud infrastructure is usually realized by a multi-tenant system that shares resources such as memory, CPU (Central Processing Unit) etc. among the tenants. Virtualization mechanisms are used to assign each tenant an isolated environment that resembles a physical machine. However, in real world-scenarios, these isolated environments share common resources like internal networking, memory, CPU, which can impact the tenant's workload performance significantly.

### BRIEF DESCRIPTION OF THE FIGURES

Some examples of apparatuses and/or methods will be described in the following by way of example only, and with reference to the accompanying figures, in which:

FIG. 1a shows a schematic diagram of an example of an apparatus or device for a computer system, and of a computer system comprising such an apparatus or device;

FIG. 1b shows a flow chart of an example of a method for a computer system;

FIG. 2 shows a schematic diagram illustrating the challenge of a noisy neighbor in a public cloud infrastructure;

FIG. 3 shows a pseudocode of an example implementation of the FUNC function for detecting noisy neighbors;

FIG. 4 shows a pseudocode of an example implementation of the FUNC_UTILIZATION function;

FIG. 5 shows a flow chart of a high-level flow of an example of the proposed concept;

FIG. 6 shows a flow chart of an example operational flow of QoS threshold calculation from dynamic observed platform telemetry; and

FIG. 7 shows a flow chart of an example operational flow of a noisy neighbor detection scenario and example mitigation scenarios.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

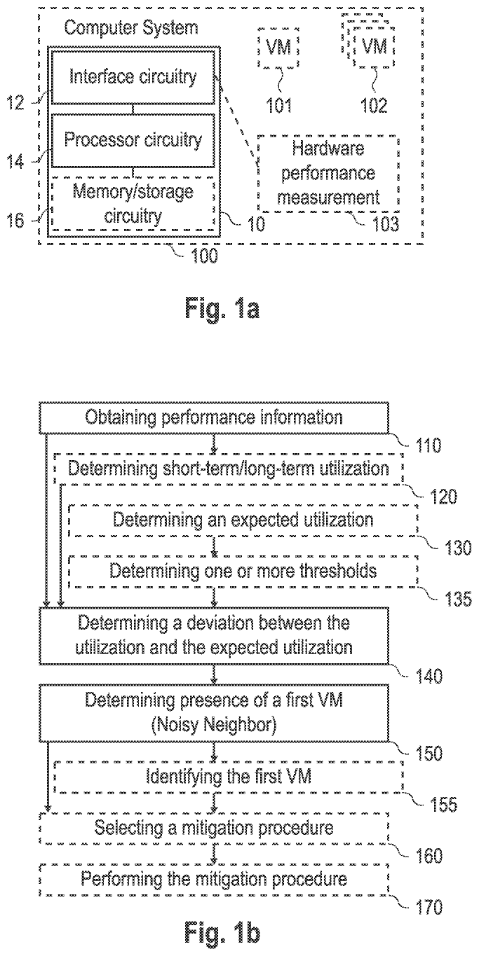

FIG. 1a shows a schematic diagram of an example of an apparatus 10 or device 10 for a computer system 100, and of a computer system 100 comprising such an apparatus 10 or device 10. The apparatus 10 comprises circuitry to provide the functionality of the apparatus 10. For example, the circuitry of the apparatus 10 may be configured to provide the functionality of the apparatus 10. For example, the apparatus 10 of FIG. 1a comprises interface circuitry 12, processor circuitry 14, and (optional) memory/storage circuitry 16. For example, the processor circuitry 14 may be coupled with the interface circuitry 12 and/or with the memory/storage circuitry 16. For example, the processor circuitry 14 may provide the functionality of the apparatus, in conjunction with the interface circuitry 12 (for communicating with other entities inside or outside the computer system 100, such as with a hypervisor, one or more virtual machines 101, 102, and/or hardware performance measurement components/circuitry 103), and the memory/storage circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIG. 1a comprises means for processing 14, which may correspond to or be implemented by the processor circuitry 14, means for communicating 12, which may correspond to or be implemented by the interface circuitry 12, (optional) means for storing information 16, which may correspond to or be implemented by the memory or storage circuitry 16. In general, the functionality of the processor circuitry 14 or means for processing 14 may be implemented by the processor circuitry 14 or means for processing 14 executing machine-readable instructions. Accordingly, any feature ascribed to the processor circuitry 14 or means for processing 14 may be defined by one or more instructions of a plurality of machine-readable instructions. The apparatus 10 or device 10 may comprise the machine-readable instructions, e.g., within the memory or storage circuitry 16 or means for storing information 16.

The processor circuitry 14 or means for processing 14 is to obtain performance information of one or more hardware performance measurement components 103 of the computer system. The processor circuitry 14 or means for processing 14 is to determine, based on the performance information, a deviation of a utilization of the computer system from an expected utilization of the computer system. The processor circuitry 14 or means for processing 14 is to determine presence of a first virtual machine 101 having a workload that impacts a performance of one or more second virtual machines 102 based on the deviation.

FIG. 1b shows a flow chart of an example of a corresponding method for a computer system, e.g., for the computer system 100. The method comprises obtaining 110 the performance information of the one or more hardware performance measurement components 103 of the computer system. The method comprises determining 140, based on the performance information, the deviation of the utilization of the computer system from the expected utilization of the computer system. The method comprises and determining 150 the presence of the first virtual machine 101 having a workload that impacts a performance of the one or more second virtual machines 102 based on the deviation. For example, the method may be performed by the computer system 100, e.g., by the apparatus 10 or device 10 for the computer system 100.

In the following, the functionality of the apparatus 10, device 10, method and of a corresponding computer program will be discussed in greater detail with reference to the apparatus 10. Features introduced in connection with the apparatus 10 may likewise be included in the corresponding device 10, method and computer program.

Various examples of the present disclosure relate to the detection and mitigation of noisy neighbors in public cloud infrastructures. In the context of virtual machines (VMs) being hosted in a public cloud, a noisy neighbor refers to a VM on the same physical server (also known as a hypervisor or host machine, such as the computer system 100) that makes excessive use of shared resources, such as CPU (Central Processing Unit) resources, memory, I/O (Input/Output) bandwidth, or network capacity. As most public cloud environments use multi-tenant infrastructures, where VMs from different customers can reside on the same physical hardware (i.e., the computer system 100), resources are generally shared among those VMs. Presence of a noisy neighbor can lead to resource starvation. For example, if a VM consumes the majority of the available CPU cycles, memory, I/O bandwidth and/or network bandwidths, other VMs on the same host may not perform optimally because they do not have access to a sufficient selection of resources. Moreover, some workloads, e.g., workloads using instruction set extensions, such as vector or matrix multiplication extensions of an instruction set of the CPU can lead to the clock frequency of cores used by other VMs being reduced to account for the thermal load caused by the use of these instruction set extensions.

While, in laboratory settings with known workloads, it is feasible to detect anomalies in the use of resources shared by multiple virtual machines, the same cannot easily be said for real-world scenarios with heterogeneous workloads that are not known to the hypervisor or fleet manager. Such a scenario is present in public cloud infrastructures, where virtual machines are spun up for multiple tenants, for custom workloads that are not initially known to the hypervisor/virtual machine manager (VMM) or fleet manager. For these kinds of scenarios, the present disclosure provides an approach for detecting the presence of noisy neighbors (i.e., the first virtual machine, of which the presence is detected is the noisy neighbor) on computer systems being used in the context of public cloud infrastructure.

The proposed concept is based on a comparison between a current utilization of the computer system and an expected utilization of the computer system. To determine both the current utilization and the expected utilization, utilization data (i.e., the performance information) is acquired from the one or more hardware performance measurement components 103 of the computer system. For example, the one or more hardware performance measurement components may measure and/or compile performance information with respect to the utilization of the computer system at a hardware level. The performance information may include information on one or more of a core frequency of one or more processing cores of a central processing unit (CPU) of the computer system, a core frequency of an uncore of the CPU (uncores are cores of the CPU that are not processing cores, such as a memory controller core, an I/O controller core, an interconnect, a power management core etc.), a core frequency of one or more processing core of another processing unit of the computer system (apart from the CPU), such as a core frequency of a graphics processing unit (GPU), a core frequency of an artificial intelligence accelerator, a core frequency of an offloading circuitry of the computer system, or, more generally, a core frequency of any kind of XPU (X-Processing Unit, with X representing different kinds of processing units) of the computer system. The performance information may include information on a power use of the computer system (and its components, such as the CPU and/or one or more XPUs). The performance information may include information on a memory use, information on a memory bandwidth being used, information on an I/O bandwidth (e.g., disk I/O bandwidth) being used, information on a network bandwidth being used. In summary, the performance information may comprise one or more information components of the group of information on a frequency of a processor core of a processor of the computer system, information on a frequency of an uncore of the computer system, information on a memory bandwidth being used in the computer system, information on a memory utilization, information on an input/output bandwidth being used in the computer system, information on an input/output utilization, information on a utilization of a processing unit being separate from the processor of the computer system, and information on a power use in the computer system. For example, the performance information may be indicative of the workload having an impact on the performance of the one or more second virtual machines.

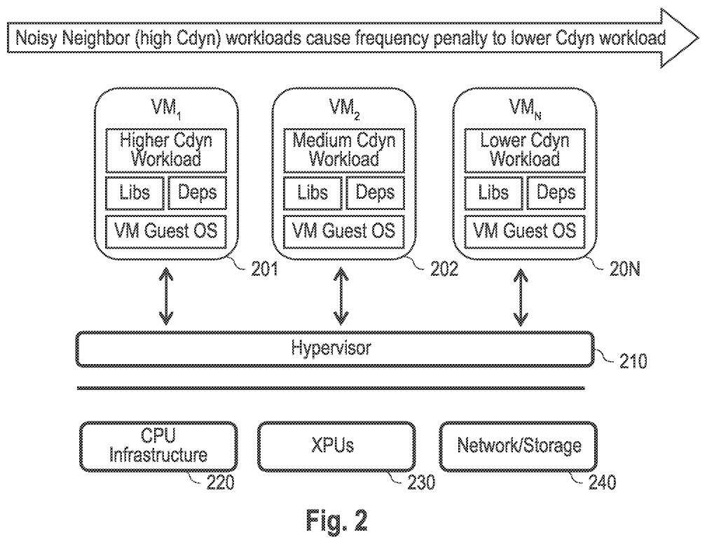

In general, single samples of performance information may be unsuitable for gaining an insight into the utilization of the computer system, and thus also for determining the presence of noisy neighbors, as single samples usually only represent short time frames. However, workloads often vary heavily over time, even if the tasks being performed as part of the workloads do not change, e.g., as new data is being fetched from disk, results are being exchanged among nodes or between server and client etc. Therefore, the utilization being considered by the proposed concept may be averaged over time. In particular, in some examples of the present disclosure, two different averages may be considered—a short-time average (in the context of FIGS. 1a and 1b, this average is denoted first shorter-term average, and in the context of FIGS. 2 to 7, this average is denoted STA) and a long-term average (in the context of FIGS. 1a and 1b, this average is denoted second longer-term average, and in the context of FIGS. 2 to 7, this average is denoted LTA), with the short-term average coving a fewer number of samples of performance information and a shorter period of time, and the long-term average covering a larger number of samples of performance information and a longer period of time. The processor circuitry may determine at least one of the first shorter-term average utilization and the second longer-term average utilization of the computer system based on the performance information. Accordingly, as further shown in FIG. 1b, the method may comprise determining 120 at least one of the first shorter-term average utilization and the second longer-term average utilization of the computer system based on the performance information. The deviation may then be determined based on at least one of the first shorter-term average utilization and the second longer-term average utilization.

In general, the time windows and/or number of samples of performance information being used for determining the first shorter-term average utilization and the second longer-term average utilization may be different depending on the concrete scenario. For example, in a microservices scenario, where instances of virtual machines are spun up and torn down frequently, other time windows and number of samples may be used than in a webhosting scenario or a machine-learning training scenario, where the same workloads persist over a longer period of time. For example, at least one of a first number of samples (and/or window of time) used to determine the first shorter-term average utilization and a second number of samples (and/or window of time) used to determine the second longer-term average utilization may be configurable. In particular, the number of samples and/or window of time being used may be policy-configurable and implementation specific.

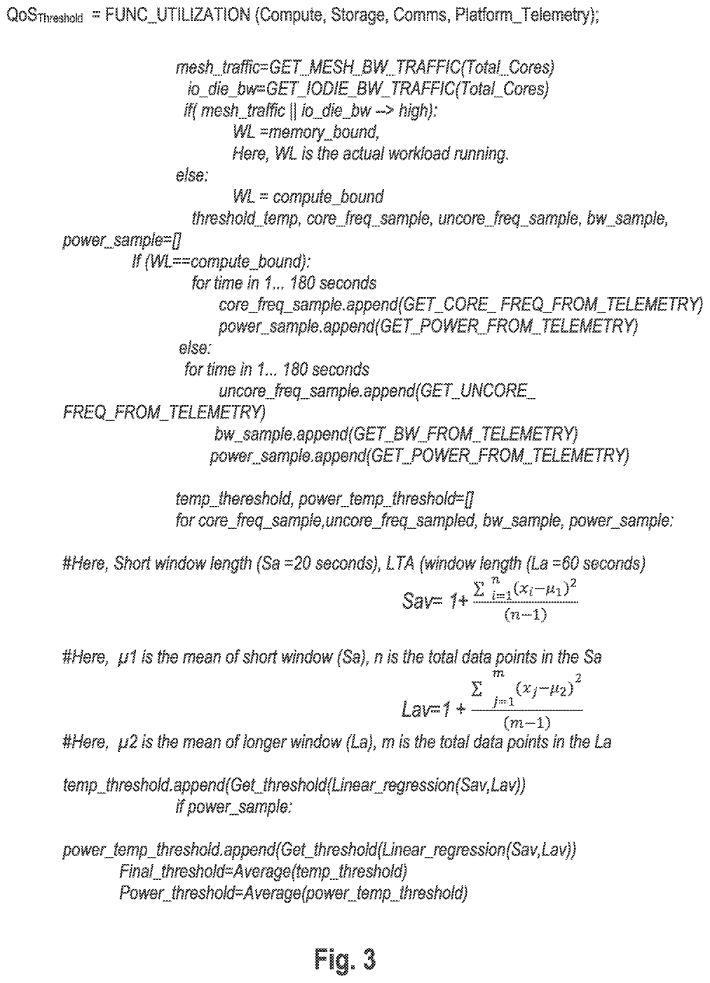

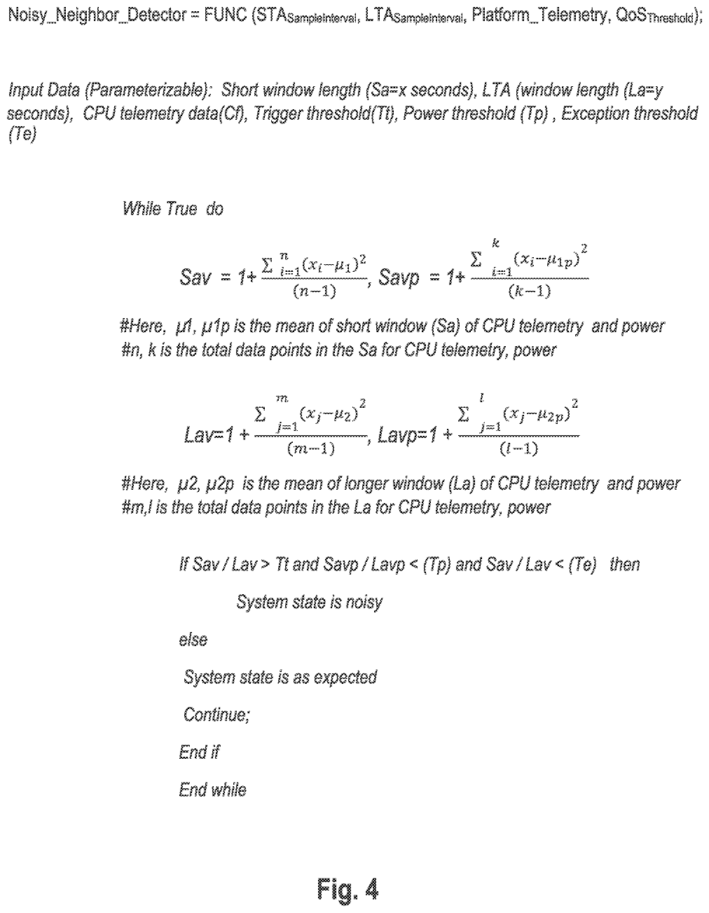

In an example implementation shown in FIGS. 3 to 6, the first shorter-term average utilization and the second longer-term average utilization include the variance of the respective component of the performance information over the respective number of samples or window of time. Variance is a measure of the spread between numbers in a data set and is is calculated by taking the average of the squared differences between each data point and the mean of the data set. Examples for this are given in the algorithms of FIGS. 3 and 4, where the variance of the respective core frequencies and the power are determined and determined as part of the first shorter-term average utilization and the second longer-term average utilization, with Say representing the variance of the core frequencies over the STA, Savp representing the variance of the power over the STA, Lav representing the variance of the core frequencies over the LTA, and Lavp representing the variance of the power over the LTA. It is evident that both the performance information and the current utilization can include multiple components, such as core frequencies, power, I/O bandwidth etc. In other words, the performance information may comprise two or more different information components, and the first shorter-term average utilization and/or the second longer-term average utilization may be determined separately for each of the two or more different information components.

To determine the deviation of the current utilization from the expected utilization, two different approaches may be used (and, in some cases, combined)—in a first approach, the expected utilization may be pre-defined, e.g., as the expected utilization is based on models or a fleet-wide historical utilization. Alternatively, the expected utilization may be determined on-device. In other words, the processor circuitry may determine, based on historical and/or current performance information, the expected utilization of the computer system. Accordingly, as further shown in FIG. 1b, the method may comprise determining 130, based on the historical and/or the current performance information, the expected utilization of the computer system. The calculations being performed for determining the expected utilization may be based on the calculations for determining the first shorter-term average utilization and the second longer-term average utilization, albeit over more samples and/or more time windows. For example, the expected utilization may be determined by determining a linear regression over multiple samples of first shorter-time average utilization and/or second longer-term average utilization. In other words, the expected utilization may be determined using a linear regression algorithm or a linear regression model. This expected utilization may then be used to determine one or more thresholds that are subsequently used to determine, whether the deviation between the current utilization and the expected utilization is based on a noisy neighbor VM. In other words, the processor circuitry may determine one or more thresholds for the determination of the deviation between the utilization of the computer system and the expected utilization of the computer system, based on the expected utilization of the computer system. Accordingly, the method may comprise determining 135 one or more thresholds for the determination of the deviation between the utilization of the computer system and the expected utilization of the computer system. As stated in connection with the respective average utilization, different components of the performance information may be considered separately. In other words, if the performance information comprises two or more different information components, the processor circuitry may determine at least one threshold for each of the different information components. Accordingly, the processor circuitry may determine the deviation separately for the different information components.

As is evident from the above example implementation, it may take time to learn the expected utilization of the computer system, as the linear regression is to be performed over some time to yield precise results. When the computer system starts up or is used for entirely new tenants, the expected utilization may not be derivable from prior data. In such cases, the processor circuitry may determine the expected utilization of the computer system by iteratively refining the expected utilization, starting from an initial expected utilization supplied as a parameter. Accordingly, the method may comprise determining 130 the expected utilization of the computer system by iteratively refining the expected utilization, starting from the initial expected utilization supplied as a parameter. This initial expected utilization may be based on a fleet-wide expected utilization determined over a fleet of computer systems.

Once both the current (average) utilization and the expected utilization are known, the deviation can be determined. The processor circuitry is to determine, based on the performance information, the deviation (e.g., an absolute difference, or a difference in percent) of the (current) utilization of the computer system (e.g., the first shorter-term average and/or the second longer-term average) from the expected utilization of the computer system. As the performance information may comprise multiple different information components, the deviation may be determined separately for the different information components. If the comparison yields that the (current) utilization deviates from the expected utilization too much, it can be assumed that a noisy neighbor is present. In this case, the processor circuitry determines the first virtual machine 101 having a workload that impacts a performance of one or more second virtual machines 102 (i.e., the presence of a noisy neighbor virtual machine, the noisy neighbor virtual machine being the first virtual machine having a workload that impacts a performance of one or more second virtual machines 102) based on the deviation. For example, presence of the first virtual machine (i.e., of the noisy neighbor VM) may be determined when one of or both the first shorter-term average utilization and the second longer-term average utilization deviate from the expected utilization of the computer system, e.g., by a pre-defined or determined amount. In particular, presence of a noisy neighbor VM may be determined if the deviation violates the determined threshold(s).

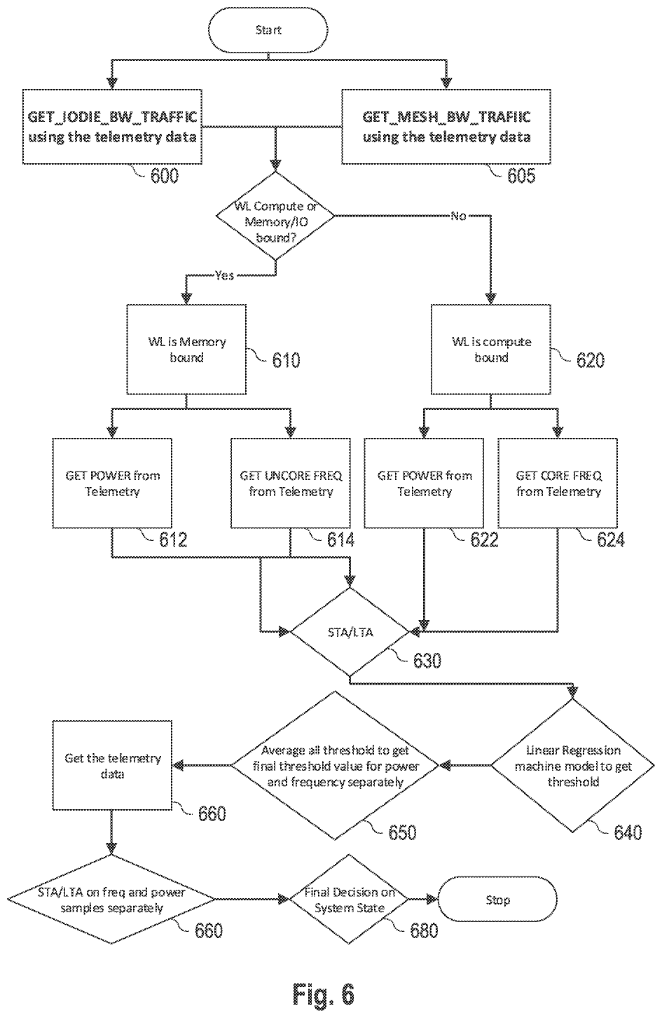

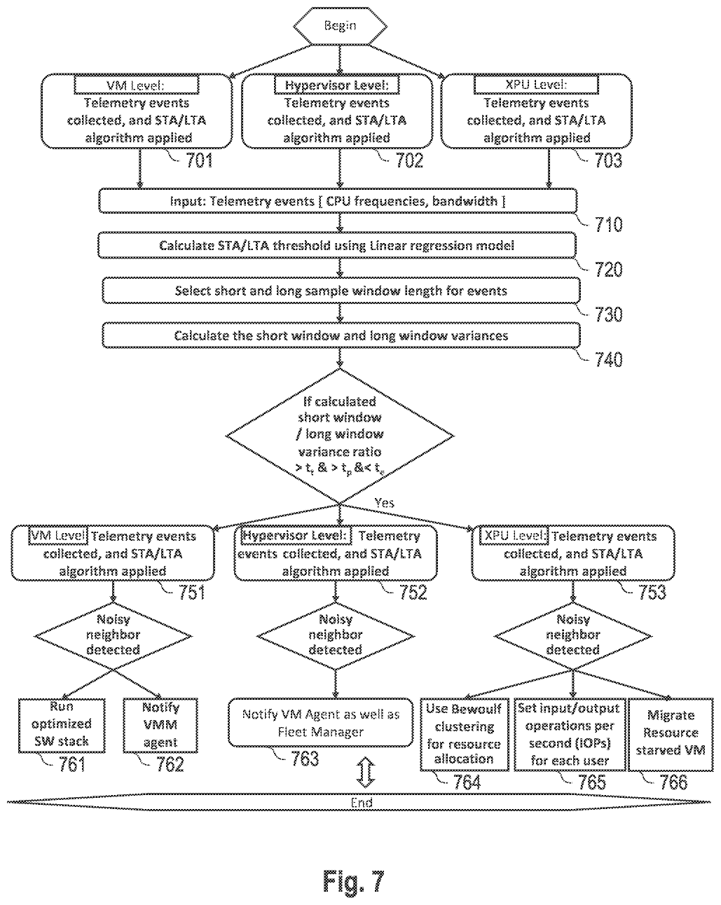

In case a noisy neighbor is present, one or more mitigation procedures may be performed. In other words, the processor circuitry may perform a mitigation procedure with respect to the first virtual machine or with respect to the one or more second virtual machines after determining presence of the first virtual machine. Accordingly, as further shown in FIG. 1b, the method may comprise performing 170 the mitigation procedure with respect to the first virtual machine or with respect to the one or more second virtual machines after determining presence of the first virtual machine. In general, the aim of a mitigation procedure may be to improve the performance of the one or more second virtual machines, i.e., of the virtual machine(s) being impacted by the noisy neighbor VM. This can be achieved in different ways, which are discussed in connection with FIGS. 6 and 7. For example, the mitigation procedure may comprise at least one of running a different software stack in at least one virtual machine (e.g., in the first VM, to reduce the “noisy” behavior, or at least one of the one or more second VMs, to reduce the performance impact of the first VM), notifying a virtual machine manager (VMM) agent (e.g., to trigger the VMM to migrate at least one VM to another computer system/host), notifying a fleet manager (e.g., to trigger the fleet manager to migrate at least one VM to another computer system/host), assigning additional resources of a resource cluster (e.g., to increase the resources that are available for use by the virtual machines), limiting a number of input/output operations for at least one virtual machine (e.g., for each VM, or only for the first VM if the first VM can be identified) and migrating at least one virtual machine (e.g., a second virtual machine, to another host). It is evident that different mitigation procedures may be applicable in different scenarios, such that the above listing can be seen as pool of possible mitigation procedures, of which one or more can be selected. For example, the processor circuitry may select a mitigation procedure from a plurality of mitigation procedures (e.g., of the above listing) based on the deviation, and to perform the selected mitigation procedure. Accordingly, as shown in FIG. 1b, the method may comprise selecting 160 a mitigation procedure from a plurality of mitigation procedures based on the deviation and performing 170 the selected mitigation procedure. For example, the processor circuitry may select a mitigation procedure with respect to the first virtual machine or with respect to the one or more second virtual machines based on a threshold of the one or more thresholds being violated by the utilization of the computer system. For example, as the determination of which of the thresholds is being violated provides some insight on which resource is impacted by the noisy neighbor VM, this information can be used to determine whether additional resources are to be provided to the VMs, or whether some resources (such as I/O operations per second) should be restricted to allow the one or more second VMs to operate with improved performance. Which mitigation procedure is being selected depends on the scenario and can be configured by the fleet manager. In other words, the plurality of mitigation procedures and/or the selection of the mitigation procedure may be policy-configurable.

The previous examples primarily relate to the determination of a noisy state, i.e., of a state in which a noisy neighbor VM is present. However, in some cases, it may be useful to identify which VM is the noisy neighbor, so the VM can be additionally constrained, or the operator of the VM can be charged for the behavior of the virtual machine. For example, the processor circuitry may identify the first virtual machine among a plurality of virtual machines, with the remaining virtual machines being the one or more second virtual machines. Accordingly, as further shown in FIG. 1b, the method may comprise identifying 155 the first virtual machine among the plurality of virtual machines. For example, the first virtual machine may be identified based on a resource utilization of the first virtual machine. For example, the hypervisor, or the operating system of the respective VMs, may determine the resource utilization of the respective virtual machine(s), and then use the resource utilization of the virtual machines to identify the first virtual machine.

As will become evident in connection with FIGS. 3 to 7, the proposed technique can be applied at different levels. For example, at least some of the functionality discussed in connection with FIGS. 1a and 1b may be provided at different levels and by different components, such as by an agent running inside the VMs, by a hypervisor, or by an XPU. For example, the performance information may be provided by the hypervisor, by the different VMs, and/or by one or more XPUs. The determination of the current (average) and expected utilization may likewise be performed by the by the hypervisor, by the different VMs, and/or by one or more XPUs. Similarly, the determination of the deviation, and the triggering or performance of mitigation procedures may be performed by the hypervisor, by the different VMs, and/or by one or more XPUs.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processor circuitry 14 or means for processing 14 may be implemented using one or more processing units, one or more processing devices, any means for processing, such as a processor, a computer or a programmable hardware component being operable with accordingly adapted software. In other words, the described function of the processor circuitry 14 or means for processing may as well be implemented in software, which is then executed on one or more programmable hardware components. Such hardware components may comprise a general-purpose processor, a Digital Signal Processor (DSP), a micro-controller, etc.

For example, the memory or storage circuitry 16 or means for storing information 16 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the apparatus 10, device 10, computer system 100, method and computer program are mentioned in connection with the proposed concept, or one or more examples described above or below (e.g., FIG. 2 to 7). The apparatus 10, device 10, computer system 100, method and computer program may comprise one or more additional optional features corresponding to one or more aspects of the proposed concept, or one or more examples described above or below.

Various examples of the present disclosure relate to a concept for Dynamic Non-Intrusive Noisy Neighbor Detection (DNNND) for XPUs (X Processing Units, where X can stand for a variety of different processing units) in public cloud infrastructures.

FIG. 2 shows a schematic diagram illustrating the challenge of a noisy neighbor in a public cloud infrastructure. FIG. 2 shows three VMs, VM1 201, VM2 202 and VM203, which run atop a hypervisor 210 that provides virtualized access to the hardware, e.g., to the CPU infrastructure 220, XPUs 230 and network/storage 240. Each of the VMs includes a workload, libraries, dependencies and a VM guest Operating System (OS). VM1 has a workload being based on instructions having a first higher Cdyn (dynamic capacitance), VM2 has a workload being based on instructions having a second medium Cdynand VMN has a workload being based on instructions having a third lower Cdyn. Higher Cdyn instructions usages in a VM can cause the overall SoC power to go high thereby causing a penalty in terms of frequency for both cores running higher as well as lower Cdyn resulting in a noisy neighbor being present. Other forms of noisy neighbor include execessive usage of shared resources such as memory, cache, I/O lanes, etc. Noisy Neighbor workloads (being based on instructions having the first higher and second medium Cdyn) cause frequency penalty to workloads being based on instructions having the third lower Cdyn, e.g., by causing a CPU frequency or memory hit. More precisely, an AI (Artificial Intelligence) workload using the instructions being based on instructions having a higher Cdyn causes a noisy neighbor impact in terms of CPU core frequency and memory bandwidth to co-existing workloads being based on instructions having a lower Cdyn. Users/developers of individual VMs cannot quantify that the workload performance impact is due to co-existing noisy neighbor with present techniques.

In such an infrastructure, there is always a risk that one tenant over-consumes resources which causes negative and unstable performance on the co-tenant workload which is also termed as Noisy neighbor issue. The presence of a noisy neighbor is a significant issue for public cloud customers as well as Cloud Service Providers. At the same time, it is a challenge to detect noisy neighbor issues effectively and take mitigations. Noisy neighbors incur in performance regression, poor TCO (Total Cost of Ownership), poor UX (User Experience), etc. and can happen for many different reasons (workload configuration, noisy neighbors, platform power/thermal throttling, etc.). This is a key concern from CSPs.

The present disclosure provides a concept for Dynamic Non-Intrusive Noisy Neighbor Detection (DNNND) for XPUs in Public Cloud Infrastructure to efficiently detect noisy neighbor issue in a non-intrusive manner.

Today, technologies such as Intel® RDT (Resource Director Technology) work around the challenge by means of reserving dedicated resources at prior as there is no effective way to detect noisy neighbors. Other approaches generally do not provide the capability to detect the noisy neighbor scenario in a non-intrusive scalable manner. There are few potential mitigation (again, not for detection) to eliminate the risk of this issue. For example, the tenant may buy reserved capacity, migrate to a single tenant infrastructure, and/or design their code to reduce the impact of the resource throttling issue. Service providers can monitor usage of all tenants continuously and apply resource governance. However, these mitigations incur high costs for the respective tenants and can lead to resource wastage.

In one approach, a Convolutional Neural Network (CNN) was leveraged to detect noisy neighbors and achieved good accuracy. However, it used few workloads for data collection. For example, a CNN was used to detect noisy neighbors for a voice-over IP application using CNN. In general, AI/CNNs operate based on the models and dataset they are trained with, which is not scalable to the public cloud usage scenario wherein customers/tenants and cloud service providers do not know the exact workload that can be used for model training and fine tuning. Additionally, this is not a practical solution as there are many benchmarking workloads and each behaves different in different scenarios. To capture behavior of each workload may be considered infeasible. Without representing sufficiently different behaviors in the training data, it is difficult to get accurate or near-accurate predictions. Other than this, AI-based predictions generally also incur CPU overhead while executing it in parallel to the workload, which may affect workload performance. Therefore, this technique might only be used once the workload finishes, which would result in a waste of resources and time.

The proposed Dynamic Non-Intrusive Noisy Neighbor Detection (DNNND) for XPUs in Public Cloud Infrastructure may aim to mitigate the noisy neighbor scenario in (public) cloud infrastructures. Various examples of the proposed concept may involve a method and apparatus to derive real-time telemetry on key performance counters, such as compute frequency, memory utilization and I/O (Input/Output) utilization, across fine-granular (short/burst interval) and/or long duration intervals to derive a dynamic threshold for a given workload. Based on the derived dynamic threshold, a deviation of key performance indicators from an expected range may be detected to identify a case of noisy neighbor/resource starvation. Parametrizable thresholds that can be self-learnt for a specific deployment scenario and adapted may be used to detect the noisy neighbor. For example, a hierarchical scalable agent-based approach across the full solution stack and across nodes in each fleet may be used to identify a crowd-sourced fingerprint of a noisy neighbor to eliminate false positives, as the proposed approach is scalable across workloads running within a single Guest VM and across multiple Guest VMs running on a single platform (e.g., 1 socket or 2 socket or 4 socket or 8 socket) as well as a cluster of platforms (i.e., fleet in a data center). The detection of noisy neighbors and the triggering of mitigation actions can be done in real-time, without waiting for the workload to finish.

The proposed concept can be applied on at least one of three levels of granularity if infrastructure policy permits: On user-level (e.g., all VMMs), on hypervisor level, and/or on XPU level. In various examples, a Short-Term Average (STA)/Long Term Average (LTA) algorithm is employed, which can detect the sudden system behavior change using CPU telemetry events.

The proposed concept may efficiently detect a noisy neighbor in a parameterizable threshold and sampling interval based on the platform run-time telemetry. It may result in an improved TCO in terms of efficient use of platform resources. Examples may help CSPs to handle XPU over-subscription scenarios without Denial Of Service, thereby also achieving improved TCO. The proposed concept may be used by, or integrated in, public cloud performance telemetry/performance monitoring tools/reports.

The impact of noisy neighbors is felt, by other VMs, with respect to the following performance metrics (in order of importance): core/uncore frequency, memory bandwidth/latency and I/O bandwidth/latency that result in performance regression, poor TCO, poor UX, etc. and can happen for many different reasons (workload configuration, noisy neighbors, platform power/thermal throttling, etc.).

In the present disclosure, a lightweight telemetry driven algorithm is proposed to detect noisy neighbors. This (Short-Time-Average/Long-Time-Average (STA/LTA)) can execute in parallel with the workload without introducing (much) additional overhead and without impacting the performance negatively.

The proposed algorithm involves one or more of the following aspects: Key performance counters telemetry (such as (core) frequency, memory bandwidth/utilization, I/O bandwidth/utilization and/or power) may be retrieved in a periodic cadence to derive two key utilization metrics:

QoS_{Threshold} = FUNC_UTILIZATION (compute, storage, comms,
platform_telemetry);

wherein compute—refers to core/mesh/I/O frequency and utilization, storage refers to DRAM (Dynamic Random Access Memory)/persistent memory bandwidth/utilization, comms refers to the I/O bandwidth/utilization, and platform_telemetry refers to the performance and power counters across compute, storage and comms from the platform that provides the utilization metric of a given VM workload in a platform. FIG. 4 shows a pseudocode of an example implementation of the FUNC_UTILIZATION function.

Noisy_Neighbor_Detector = FUNC (STA_{SampleInterval}, LTA_{SampleInterval},
platform_telemetry, QoS_{Threshold});

wherein STA_{SampleInterval} & LTA_{SampleInterval} refer to the configurable sampling interval, QOS_{Threshold} refers to the threshold derived for the specific workload and configuration to assert noisy Neighbor. FIG. 3 shows a pseudocode of an example implementation of the FUNC function for detecting noisy neighbors.

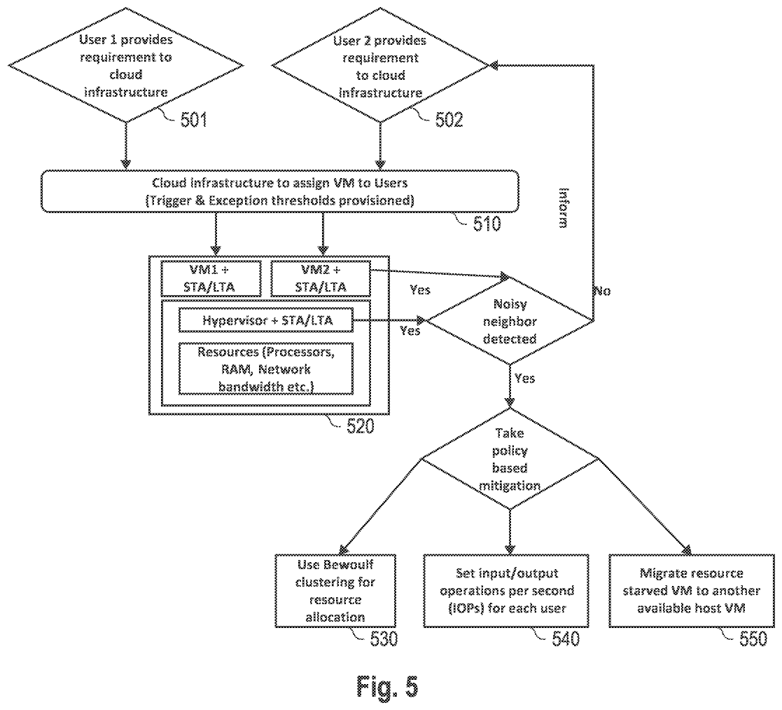

The proposed algorithm is parameterizable in terms of thresholds expected as well as percent of deviation from thresholds to assert noisy neighbor detection based on heuristics/AI based approaches. This algorithm can also be scaled at hypervisor and XPU levels to detect the present issue by the VMM agent and fleet manager (see FIG. 5). Also, the proposed concept can be scaled across one-to-many nodes in terms of telemetry finger-print across a fleet to capture noisiness.

In the present disclosure, a lightweight algorithm is proposed, as shown in FIG. 4 (Short-Time-Average/Long-Time-Average (STA/LTA)), which can execute in parallel with the workload without introducing additional overhead and resulting in no performance impact. Here, STA is sensitive to the sudden change in signals while LTA has the temporal amplitude information of the signal. The proposed algorithms are resource and energy efficient algorithms and fit the scope of the challenge well. In the present case, CPU frequency may be monitored to notice any sudden behavior change to detect noisy neighbor.

With this algorithm (STA/LTA module), sudden behavior change may be detected by variance difference. To calculate the variance difference, one or more of the following parameters may be calculated. First is Lₐ, which denotes the long window (a longer window of x seconds) of CPU frequency and Lₐᵥ denotes the long window variance. Second is Sₐ, which denotes the short window (a shorter window of y seconds, with y<z) of CPU frequency and Sₐᵥ denotes the short window variance. Last parameter is the ratio(R)=Lₐᵥ/Sₐᵥ that is denoted with Tₜ. Sₐ, Lₐ and threshold value (K) with system state like thermal throttling, sudden spike in frequency, TDP (Thermal Design Power) being limited, and bandwidth limited. Tₜ may be compared against a self-learned threshold calculation algorithm which uses Linear regression, thereby learning based on the experimentation data collected, providing a light-weight model.

The trigger threshold determines which events are flagged and which are not. The higher the value is set, the more events that would need to be flagged are be missed. The lower the threshold, the more sensitive the algorithm may be come, which may result in falser triggers (burdening the fleet manager) and a higher amount of CPU resources being used. An improved threshold may be selected that depends on the workload's nature, which may be determined by going through historical data from a bare metal or standalone config (projection) to identify a suitable ratio that avoids false triggers. For completely new workloads, some time may be used to learn about its behavior, which may then be used to calibrate the threshold using the Linear regression model. This algorithm can also be implemented at the hypervisor and XPU levels to detect the issue by the VMM agent and fleet manager (see FIG. 5). For example, when the ratio of the short-term CPU frequency variances (Sₐᵥ) and the long-term frequency variance (Lₐᵥ) exceeds a trigger threshold value, the state of the system may be classified as noisy.

There may be cases that require more analysis to reduce false positive cases. For example, in a first scenario, this may be the case when a workload transitions from data processing to compute mode. In a second scenario, this may be the case when the workload transitions from compute mode to active idle mode. These two scenarios introduce high ratio of Lₐᵥ/Sₐᵥ and some STA/LTA algorithms may detect it as noisy state whereas the system is actually in normal state as this behavior is as expected. To address this behavior, a condition is introduced that, if the threshold value(K) is greater than Z (Determined by the workload's nature, which may be determined by going through historical data from a bare metal or standalone configuration (projection)), then the state may be considered to be a normal state. The same methodology may be applied for uncore frequency and bandwidth.

FIG. 5 shows a flow chart of a high-level flow of an example of the proposed concept from use case exposure at a public cloud infrastructure providing noisy neighbor detection and mitigation policies, that can be governed and enforced at various granularities (XPU, VMM, Guest OS). In the flow shown in FIG. 5, at 501, a first user provides a requirement to a cloud infrastructure 510, and a 502, a second user provides a requirement to the cloud infrastructure 510. The cloud infrastructure 510 assigns VMs to users (with trigger and exception thresholds provisioned). FIG. 5 shows the cloud infrastructure hardware 520, with resources (such as processors, random-access memory, network bandwidth etc.) and a hypervisor (which is used to calculate the STA/LTA at hypervisor level). The cloud infrastructure hardware 520 is used to host the VMs for the first and second user, with the VMs calculating the STA/LTA at VM level. The STA/LTA calculated at VM- and hypervisor level are used to detect presence of a noisy neighbor. If no noisy neighbor is determined, the user(s) is/are informed. If a noisy neighbor is detected, a policy-based mitigation is taken, such as using Beowulf clustering for resource allocation (530), setting input/output operations per second for each user (540) and/or migrating a resource-starved VM to another available host (550).

FIG. 6 shows a flow chart of an example operational flow of QoS threshold calculation from dynamic observed platform telemetry. The flow starts by obtaining the bandwidth traffic from the input/output die (see block 600) and the bandwidth traffic from the mesh (see block 605). Then, a determination is made if the workload is compute-bound (see block 620) or memory/input/output bound (see block 610). If the workload is memory-bound (610), power information 612 and uncore frequency information 614 is obtained from telemetry and input into the STA/LTA algorithm 630. If the workload is compute-bound (620), the power information 622 and core frequency information 624 is obtained from telemetry and input into the STA/LTA algorithm 630. At 640, a linear regression machine model is used to obtain a threshold. At 650, the thresholds are averaged to obtain a final threshold value for power and frequency separately. At 660, the telemetry data is obtained, and at 670 the STA/LTA is determined on frequency and power samples separately. At 680, a final decision is taken on the system state.

In the present disclosure, it was shown how the STA/LTA algorithm can help in detecting the noisy neighbor phenomenon, which is a untrivial issue in cloud infrastructure. Once the noisy neighbor is detected, the following actions can be taken by the cloud infrastructure or user (see FIG. 7).

FIG. 7 shows a flow chart of an example operational flow of a noisy neighbor detection scenario and example mitigation scenarios. In the flow shown in FIG. 7, telemetry events (such as CPU frequencies, bandwidth) are collected (710) and the STA/LTA algorithm is applied (by calculating 720 STA/LTA thresholds using a linear regression model, selecting 730 a short and long sample window length for events, and calculating 740 the short window and long window variances) at VM level (701), hypervisor level (702) and XPU level (703). If the calculated short window/long window variance ration is larger than tₜ, larger than tₚ and smaller than tₑ, at VM level 751, hypervisor level 752 and/or XPU level 753, a noisy neighbor is detected. If a noisy neighbor is detected at VM level 751, an optimized software stack can be run 761 and/or the VMM (Virtual Machine Manager) agent may be notified 762. If a noisy neighbor is detected at hypervisor level 752, the VMM agent as well as the fleet manager may be notified 763. If a noisy neighbor is detected at XPU level 753, Beowulf clustering may be used 764 for resource allocation (the cloud infrastructure can implement this clustering technique to allocate resource from other idle node(s) in case of resource starvation in the current node, see Becker, Donald J; Sterling, Thomas; Savarese, Daniel; Dorband, John E; Ranawak, Udaya A; Packer, Charles V (1995). “BEOWULF: A parallel workstation for scientific computation”. Proceedings, International Conference on Parallel Processing. 95), input/output operations per second may be set 765 per for each user (the cloud infrastructure can set I/Ops to control the amount of resources each VM receives), and/or a resource-starved VM may be migrated 766 (a VM owner can migrate the resource starved VM workload to another available VM using a live VM migration tool. Clark, Christopher, Keir Fraser, Steven Hand, Jacob Gorm Hansen, Eric Jul, Christian Limpach, Ian Pratt, and Andrew Warfield. “Live migration of virtual machines.” In Proceedings of the 2nd conference on Symposium on Networked Systems Design & Implementation-Volume 2, pp. 273-286. 2005, have proposed which is capable of migrating live VMs between LAN-connected node). If a VM is often being impacted by a noisy neighbor, then workload owner can also help mitigate this by using a software stack which is improved or optimized and requires less resources. For example, a storage, communication and computations overhead in AI workloads can be reduced by sparsity and weight pruning with no or only a minimal loss in accuracy.

More details and aspects of the concept for Dynamic Non-Intrusive Noisy Neighbor Detection are mentioned in connection with the proposed concept, or one or more examples described above or below (e.g., FIG. 1a to 1b). The concept for Dynamic Non-Intrusive Noisy Neighbor Detection may comprise one or more additional optional features corresponding to one or more aspects of the proposed concept, or one or more examples described above or below.

In the following, some examples of the proposed concept are presented:

An example (e.g., example 1) relates to an apparatus (10) for a computer system (100), the apparatus (10) comprising interface circuitry (12), machine-readable instructions, and processor circuitry (14) to execute the machine-readable instructions to obtain performance information of one or more hardware performance measurement components (103) of the computer system, determine, based on the performance information, a deviation of a utilization of the computer system from an expected utilization of the computer system, and determine presence of a first virtual machine (101) having a workload that impacts a performance of one or more second virtual machines (102) based on the deviation.

Another example (e.g., example 2) relates to a previous example (e.g., example 1) or to any other example, further comprising that the performance information is indicative of the workload having an impact on the performance of the one or more second virtual machines.

Another example (e.g., example 3) relates to a previous example (e.g., one of the examples 1 or 2) or to any other example, further comprising that the processor circuitry is to execute the machine-readable instructions to determine presence of a noisy neighbor virtual machine, the noisy neighbor virtual machine being the first virtual machine.

Another example (e.g., example 4) relates to a previous example (e.g., one of the examples 1 to 3) or to any other example, further comprising that the processor circuitry is to execute the machine-readable instructions to perform a mitigation procedure with respect to the first virtual machine or with respect to the one or more second virtual machines after determining presence of the first virtual machine.

Another example (e.g., example 5) relates to a previous example (e.g., example 4) or to any other example, further comprising that the processor circuitry is to execute the machine-readable instructions to select a mitigation procedure from a plurality of mitigation procedures based on the deviation, and to perform the selected mitigation procedure.

Another example (e.g., example 6) relates to a previous example (e.g., example 5) or to any other example, further comprising that the plurality of mitigation procedures and/or the selection of the mitigation procedure is policy-configurable.

Another example (e.g., example 7) relates to a previous example (e.g., one of the examples 4 to 6) or to any other example, further comprising that the mitigation procedure comprises at least one of running a different software stack in at least one virtual machine, notifying a virtual machine manager agent, notifying a fleet manager, assigning additional resources of a resource cluster, limiting a number of input/output operations for at least one virtual machine and migrating at least one virtual machine.

Another example (e.g., example 8) relates to a previous example (e.g., one of the examples 1 to 7) or to any other example, further comprising that the processor circuitry is to execute the machine-readable instructions to determine at least one of a first shorter-term average utilization and a second longer-term average utilization of the computer system based on the performance information, and to determine the deviation based on the at least one of the first shorter-term average utilization and the second longer-term average utilization.

Another example (e.g., example 9) relates to a previous example (e.g., example 7) or to any other example, further comprising that at least one of a first number of samples used to determine the first shorter-term average utilization and a second number of samples used to determine the second longer-term average utilization is configurable.

Another example (e.g., example 10) relates to a previous example (e.g., one of the examples 8 or 9) or to any other example, further comprising that presence of the first virtual machine is determined when one of or both the first shorter-term average utilization and the second longer-term average utilization deviate from the expected utilization of the computer system.

Another example (e.g., example 11) relates to a previous example (e.g., one of the examples 1 to 10) or to any other example, further comprising that the processor circuitry is to execute the machine-readable instructions to determine, based on historical and/or current performance information, the expected utilization of the computer system.

Another example (e.g., example 12) relates to a previous example (e.g., example 11) or to any other example, further comprising that the processor circuitry is to execute the machine-readable instructions to determine the expected utilization of the computer system by iteratively refining the expected utilization, starting from an initial expected utilization supplied as a parameter.

Another example (e.g., example 13) relates to a previous example (e.g., one of the examples 11 or 12) or to any other example, further comprising that the processor circuitry is to execute the machine-readable instructions to determine one or more thresholds for the determination of the deviation between the utilization of the computer system and the expected utilization of the computer system.

Another example (e.g., example 14) relates to a previous example (e.g., example 13) or to any other example, further comprising that the performance information comprises two or more different information components, wherein the processor circuitry is to execute the machine-readable instructions to determine at least one threshold for each of the different information components.

Another example (e.g., example 15) relates to a previous example (e.g., example 14) or to any other example, further comprising that the processor circuitry is to execute the machine-readable instructions to determine the deviation separately for the different information components.

Another example (e.g., example 16) relates to a previous example (e.g., one of the examples 13 to 15) or to any other example, further comprising that the processor circuitry is to execute the machine-readable instructions to select a mitigation procedure with respect to the first virtual machine or with respect to the one or more second virtual machines based on a threshold of the one or more thresholds being violated by the utilization of the computer system, and to perform the selected mitigation procedure.

Another example (e.g., example 17) relates to a previous example (e.g., one of the examples 11 to 16) or to any other example, further comprising that the expected utilization is determined using a linear regression algorithm or a linear regression model.

Another example (e.g., example 18) relates to a previous example (e.g., one of the examples 1 to 17) or to any other example, further comprising that the processor circuitry is to execute the machine-readable instructions to identify the first virtual machine among a plurality of virtual machines, with the remaining virtual machines being the one or more second virtual machines.

Another example (e.g., example 19) relates to a previous example (e.g., example 18) or to any other example, further comprising that the first virtual machine is identified based on a resource utilization of the first virtual machine.

Another example (e.g., example 20) relates to a previous example (e.g., one of the examples 1 to 19) or to any other example, further comprising that the performance information comprises one or more information components of the group of information on a frequency of a processor core of a processor of the computer system, information on a frequency of an uncore of the computer system, information on a memory bandwidth being used in the computer system, information on a memory utilization, information on an input/output bandwidth being used in the computer system, information on an input/output utilization, information on a utilization of a processing unit being separate from the processor of the computer system, and information on a power use in the computer system.

An example (e.g., example 21) relates to an apparatus (10) for a computer system (100), the apparatus (10) comprising processor circuitry (14) configured to obtain performance information of one or more hardware performance measurement components (103) of the computer system, determine, based on the performance information, a deviation of a utilization of the computer system from an expected utilization of the computer system, and determine presence of a first virtual machine (101) having a workload that impacts a performance of one or more second virtual machines (102) based on the deviation.

An example (e.g., example 22) relates to a device (10) for a computer system (100), the device (10) comprising means for processing (14) for obtaining performance information of one or more hardware performance measurement components (103) of the computer system, determining, based on the performance information, a deviation of a utilization of the computer system from an expected utilization of the computer system, and determining presence of a first virtual machine (101) having a workload that impacts a performance of one or more second virtual machines (102) based on the deviation.

Another example (e.g., example 23) relates to a computer system (100) comprising the apparatus (10) or device (10) according to one of the examples 1 to 22 (or according to any other example).

An example (e.g., example 24) relates to a method for a computer system (100), the method (10) comprising Obtaining (110) performance information of one or more hardware performance measurement components (103) of the computer system, determining (140), based on the performance information, a deviation of a utilization of the computer system from an expected utilization of the computer system, and determining (150) presence of a first virtual machine (101) having a workload that impacts a performance of one or more second virtual machines (102) based on the deviation.

Another example (e.g., example 25) relates to a previous example (e.g., example 24) or to any other example, further comprising that the performance information is indicative of the workload having an impact on the performance of the one or more second virtual machines.

Another example (e.g., example 26) relates to a previous example (e.g., one of the examples 24 or 25) or to any other example, further comprising that the method comprises determining (150) presence of a noisy neighbor virtual machine, the noisy neighbor virtual machine being the first virtual machine.

Another example (e.g., example 27) relates to a previous example (e.g., one of the examples 24 to 26) or to any other example, further comprising that the method comprises performing (170) a mitigation procedure with respect to the first virtual machine or with respect to the one or more second virtual machines after determining presence of the first virtual machine.

Another example (e.g., example 28) relates to a previous example (e.g., example 27) or to any other example, further comprising that the method comprises selecting (160) a mitigation procedure from a plurality of mitigation procedures based on the deviation and performing (170) the selected mitigation procedure.

Another example (e.g., example 29) relates to a previous example (e.g., example 28) or to any other example, further comprising that the plurality of mitigation procedures and/or the selection of the mitigation procedure is policy-configurable. Another example (e.g., example 30) relates to a previous example (e.g., one of the examples 27 to 29) or to any other example, further comprising that the mitigation procedure comprises at least one of running a different software stack in at least one virtual machine, notifying a virtual machine manager agent, notifying a fleet manager, assigning additional resources of a resource cluster, limiting a number of input/output operations for at least one virtual machine and migrating at least one virtual machine.

Another example (e.g., example 31) relates to a previous example (e.g., one of the examples 24 to 30) or to any other example, further comprising that the method comprises determining (120) at least one of a first shorter-term average utilization and a second longer-term average utilization of the computer system based on the performance information and determining (140) the deviation based on the at least one of the first shorter-term average utilization and the second longer-term average utilization.

Another example (e.g., example 32) relates to a previous example (e.g., example 30) or to any other example, further comprising that at least one of a first number of samples used to determine the first shorter-term average utilization and a second number of samples used to determine the second longer-term average utilization is configurable.

Another example (e.g., example 33) relates to a previous example (e.g., one of the examples 31 or 32) or to any other example, further comprising that presence of the first virtual machine is determined when one of or both the first shorter-term average utilization and the second longer-term average utilization deviate from the expected utilization of the computer system.

Another example (e.g., example 34) relates to a previous example (e.g., one of the examples 24 to 33) or to any other example, further comprising that the method comprises determining (130), based on historical and/or current performance information, the expected utilization of the computer system.

Another example (e.g., example 35) relates to a previous example (e.g., example 34) or to any other example, further comprising that the method comprises determining (130) the expected utilization of the computer system by iteratively refining the expected utilization, starting from an initial expected utilization supplied as a parameter.

Another example (e.g., example 36) relates to a previous example (e.g., one of the examples 34 or 35) or to any other example, further comprising that the method comprises determining (135) one or more thresholds for the determination of the deviation between the utilization of the computer system and the expected utilization of the computer system.

Another example (e.g., example 37) relates to a previous example (e.g., example 36) or to any other example, further comprising that the performance information comprises two or more different information components, wherein the method comprises determining (135) at least one threshold for each of the different information components.

Another example (e.g., example 38) relates to a previous example (e.g., example 37) or to any other example, further comprising that the method comprises determining (140) the deviation separately for the different information components. Another example (e.g., example 39) relates to a previous example (e.g., one of the examples 36 to 38) or to any other example, further comprising that the method comprises selecting (160) a mitigation procedure with respect to the first virtual machine or with respect to the one or more second virtual machines based on a threshold of the one or more thresholds being violated by the utilization of the computer system and performing (170) the selected mitigation procedure.

Another example (e.g., example 40) relates to a previous example (e.g., one of the examples 34 to 39) or to any other example, further comprising that the expected utilization is determined using a linear regression algorithm or a linear regression model.

Another example (e.g., example 41) relates to a previous example (e.g., one of the examples 24 to 40) or to any other example, further comprising that the method comprises identifying (155) the first virtual machine among a plurality of virtual machines, with the remaining virtual machines being the one or more second virtual machines.

Another example (e.g., example 42) relates to a previous example (e.g., example 41) or to any other example, further comprising that the first virtual machine is identified based on a resource utilization of the first virtual machine.

Another example (e.g., example 43) relates to a previous example (e.g., one of the examples 24 to 42) or to any other example, further comprising that the performance information comprises one or more information components of the group of information on a frequency of a processor core of a processor of the computer system, information on a frequency of an uncore of the computer system, information on a memory bandwidth being used in the computer system, information on a memory utilization, information on an input/output bandwidth being used in the computer system, information on an input/output utilization, information on a utilization of a processing unit being separate from the processor of the computer system, and information on a power use in the computer system.

Another example (e.g., example 44) relates to a computer system (100) to perform the method according to one of the examples 24 to 43 (or according to any other example). Another example (e.g., example 45) relates to a non-transitory, computer-readable medium comprising a program code that, when the program code is executed on a processor, a computer, or a programmable hardware component, causes the processor, computer, or programmable hardware component to perform the method of one of the examples 24 to 43 (or according to any other example).

Another example (e.g., example 46) relates to a non-transitory machine-readable storage medium including program code, when executed, to cause a machine to perform the method of one of the examples 24 to 43 (or according to any other example).

Another example (e.g., example 47) relates to a computer program having a program code for performing the method of one of the examples (or according to any other example) when the computer program is executed on a computer, a processor, or a programmable hardware component.

Another example (e.g., example 48) relates to a machine-readable storage including machine readable instructions, when executed, to implement a method or realize an apparatus as claimed in any pending claim.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for a computer system, the apparatus comprising interface circuitry, machine-readable instructions, and processor circuitry to execute the machine-readable instructions to:
obtain performance information of one or more hardware performance measurement components of the computer system;
determine, based on the performance information, a deviation of a utilization of the computer system from an expected utilization of the computer system; and
determine presence of a first virtual machine having a workload that impacts a performance of one or more second virtual machines based on the deviation.

2. The apparatus according to claim 1, wherein the performance information is indicative of the workload having an impact on the performance of the one or more second virtual machines.

3. The apparatus according to claim 1, wherein the processor circuitry is to execute the machine-readable instructions to determine presence of a noisy neighbor virtual machine, the noisy neighbor virtual machine being the first virtual machine.

4. The apparatus according to claim 1, wherein the processor circuitry is to execute the machine-readable instructions to perform a mitigation procedure with respect to the first virtual machine or with respect to the one or more second virtual machines after determining presence of the first virtual machine.

5. The apparatus according to claim 4, wherein the processor circuitry is to execute the machine-readable instructions to select a mitigation procedure from a plurality of mitigation procedures based on the deviation, and to perform the selected mitigation procedure.

6. The apparatus according to claim 5, wherein the plurality of mitigation procedures and/or the selection of the mitigation procedure is policy-configurable.

7. The apparatus according to claim 4, wherein the mitigation procedure comprises at least one of running a different software stack in at least one virtual machine, notifying a virtual machine manager agent, notifying a fleet manager, assigning additional resources of a resource cluster, limiting a number of input/output operations for at least one virtual machine and migrating at least one virtual machine.

8. The apparatus according to claim 1, wherein the processor circuitry is to execute the machine-readable instructions to determine at least one of a first shorter-term average utilization and a second longer-term average utilization of the computer system based on the performance information, and to determine the deviation based on the at least one of the first shorter-term average utilization and the second longer-term average utilization.

9. The apparatus according to claim 7, wherein at least one of a first number of samples used to determine the first shorter-term average utilization and a second number of samples used to determine the second longer-term average utilization is configurable.

10. The apparatus according to claim 8, wherein presence of the first virtual machine is determined when one of or both the first shorter-term average utilization and the second longer-term average utilization deviate from the expected utilization of the computer system.

11. The apparatus according to claim 1, wherein the processor circuitry is to execute the machine-readable instructions to determine, based on historical and/or current performance information, the expected utilization of the computer system.

12. The apparatus according to claim 11, wherein the processor circuitry is to execute the machine-readable instructions to determine the expected utilization of the computer system by iteratively refining the expected utilization, starting from an initial expected utilization supplied as a parameter.

13. The apparatus according to claim 11, wherein the processor circuitry is to execute the machine-readable instructions to determine one or more thresholds for the determination of the deviation between the utilization of the computer system and the expected utilization of the computer system.

14. The apparatus according to claim 13, wherein the performance information comprises two or more different information components, wherein the processor circuitry is to execute the machine-readable instructions to determine at least one threshold for each of the different information components.

15. The apparatus according to claim 14, wherein the processor circuitry is to execute the machine-readable instructions to determine the deviation separately for the different information components.

16. The apparatus according to claim 13, wherein the processor circuitry is to execute the machine-readable instructions to select a mitigation procedure with respect to the first virtual machine or with respect to the one or more second virtual machines based on a threshold of the one or more thresholds being violated by the utilization of the computer system, and to perform the selected mitigation procedure.

17. The apparatus according to claim 11, wherein the expected utilization is determined using a linear regression algorithm or a linear regression model.

18. The apparatus according to claim 1, wherein the processor circuitry is to execute the machine-readable instructions to identify the first virtual machine among a plurality of virtual machines, with the remaining virtual machines being the one or more second virtual machines.

19. A method for a computer system, the method comprising:
Obtaining performance information of one or more hardware performance measurement components of the computer system;
determining, based on the performance information, a deviation of a utilization of the computer system from an expected utilization of the computer system; and
determining presence of a first virtual machine having a workload that impacts a performance of one or more second virtual machines based on the deviation.

20. A non-transitory, computer-readable medium comprising a program code that, when the program code is executed on a processor, a computer, or a programmable hardware component, causes the processor, computer, or programmable hardware component to perform the method of claim 19.
